(19) United States
(12) Patent Application Publication
(10) Pub. No.: US 2014/0050822 A1
(43) Pub. Date: Feb. 20, 2014

(54) MATERIAL COMPOSITE AND USE OF A MATERIAL COMPOSITE, A PACKAGING HAVING A MATERIAL COMPOSITE AND PROCESS FOR PRODUCING THE PACKAGING

(71) Applicant: Josef Rothen, Solingen (DE)

(72) Inventor: Josef Rothen, Solingen (DE)

(73) Assignee: RWR PATENTVERWALTUNG GBR, Solingen (DE)

(21) Appl. No.: 14/110,934

(22) PCT Filed: Apr. 12, 2012
(86) PCT No.: PCT/EP12/01591

§ 371 Date: Nov. 6, 2013

(30) Foreign Application Priority Data
Apr. 12, 2011 (DE) 20 2011 005 157.9

(51) Int. Cl. B65D 77/20; C09J 7/02

(52) U.S. Cl. CPC B65D 77/20; C09J 7/0296
USPC 426/127; 428/355 RA; 428/354; 428/347; 428/172; 428/195.1; 428/161; 53/477

(57) ABSTRACT

The invention relates to an adherable material composite having a large-area extent, a composite face, which extends in a first direction and in a second direction running substantially perpendicular to the first direction, and having a composite thickness extending in a third direction which runs substantially perpendicular to the composite face, wherein the material composite is formed from a first composite region and at least a second composite region which adjoins the first composite region at least in certain portions, and wherein the second composite region has adhesive properties, such that the material composite is adherable, in particular redetachably adherable, to a surface of a body by way of the composite face.

### FIELD OF THE INVENTION

The invention relates to a composite attachable to the surface of a body, having a sheetlike extent and as classified in the preamble of claim 1.

The composite accordingly comprises a composite face which extends in a first direction and in a second direction, said second direction being essentially perpendicular to the first direction. It is the composite face which is contacted on adhering the composite to the surface of a body. The composite additionally comprises a composite thickness, which extends in a third direction which is essentially perpendicular to the composite face and parallel to the composite face normal. Composite length, composite width as well as the composite thickness define the dimensions, i.e., the overall size, of the composite. The composite face is defined by the composite length and the composite width. The surface of the body can be planar or at least regionally curved, so the composite face can be flexible/curvable to conform to the surface of the body.

### TECHNOLOGICAL BACKGROUND

The art of joining together two bodies, for example a foil to a plastics packaging article or to packaging cardboard, is increasingly dependent on the use of adherents such as, for instance, a layer of adhesive applied in the region of contact between the two bodies. Adhering is a form of joining which is more and more frequently used in more and more industrial and everyday contexts (see inter alia U.S. Pat. No. 6,660,922 A). Durable adhesive joints are sought, for example as per DE 103 57 322 A1, as well as adhesive joints which have only temporary duration. There may alternatively also be a need for adhesive bonds intended to be releaseable, preferably repeatedly attachable or rereleaseable. The means which are described in U.S. Pat. No. 6,660,922 A and DE 103 57 322 A1 for adhering together materials, however, are of only limited usefulness and scarcely reusable; the adhesives described therein are unusable or at least not unreservedly usable in connection with food items in particular.

Straightforward redetachability of a foil or of an adherent layer is generally desirable for multi-trip food packaging in order that the adherent layer used for labeling the packaging may be cleaned off the packaging and the subsequently refilled packaging can be relabeled in accordance with its contents. The labeling materials used before the refilling can differ from those used after the filling. For instance, it can be advantageous in the case of (cardboard) packaging for an adhered foil, which comprises a carrier and an adherent disposed thereon, to be readily detachable with an eye to the use or reuse of the packaging.

It can alternatively be desired for a label to be quite deliberately undetachable in order that the labeling on the packaging may not be lost even in the event of, for example, careless handling. This is particularly important when the labeling on the packaging draws attention to, for example, the hazardous chemistry of the contents.

The problem with the production of (self-)adhesive materials for labeling or of process materials for the attachment or adherence of such materials is generally the adhesive-based bond between different materials, i.e., their adherence, since the materials often have different surficial properties. Thus, the surface constitution of the materials involved generally makes it difficult to dispose a foil or a plastic on a stoneware item in an adherent/adhesive manner. This is attributable to the fact that a ceramic or stoneware material needs an organic adhesive such as, for instance, cement or some silicates, whereas a surface formed of a plastic needs an inorganic adhesive comprising, for instance, a polyurethane (PU) or an epoxy resin.

### SUMMARY OF THE INVENTION

Against this background, the invention has for its object to specify measures which lead to an attachable sheetlike composite which is inexpensive to provide and is usable inter alia in the (food) packaging industry. It can further be desirable for the composite to be adherently disposable on the surfaces of a plurality of bodies composed of predetermined materials such that the properties of the adherent bond which are desired for the particular field of use—such as, for instance, bond strength, bond durability, bond formation rate and/or a desired rereleaseability of the adherent bond—are realizable as fully as possible and also with an eye to the reusability or recyclability of the materials.

This object is achieved by a composite according to claim 1 and by a method of using the invention composite according to claims 23 and 25. The problem is further also solved by a packaging article according to claim 28 and a process according to claim 32.

The invention accordingly provides a composite formed of a first composite region and at least a second composite region adjoining the first composite region at least portionally. The second composite region has adherent properties so that the composite is attachable, specifically rereleaseably attachable, with the composite face to a surface of a body. More particularly, the adherent effect can be reversible or irreversible. An irreversibly attached composite can only be removed by destroying the composite and/or the surface. A reversibly attaching composite can be detached from and reattached to the surface, at times infinitely often.

Every composite region has a composite region length, a composite region width and a composite region thickness. The composite region lengths and/or the composite region widths and/or the composite region thicknesses of the first and second composite regions can differ from each other, at least portionally. More particularly, the composite region dimensions, i.e., the composite region lengths, the composite region widths and the composite region thicknesses, can vary portionally. Portions may accordingly be provided in which, for example, the composite region thickness of the first composite region is smaller than in neighboring portions. Portions may also be provided in which the composite region thickness of one of the two composite regions has a value of 0 μm in the extreme case. Typically, the composite region thicknesses are in the range from about 0.5 μm to 5 mm. The composite region width can be between 3 mm and 10 m. The composite region length can be between 3 mm and 10 m.

Alternatively, composite regions can have portions in which the composite region thickness of a composite region is comparatively smaller and that of whichever is the other composite region is comparatively larger. As a result, the thickness of the composite is essentially constant across the full composite face, but not the thicknesses of the composite regions, which vary portionally. Portions of the composite region can in this way have different properties and functions. For example, it can be advantageous for the composite to comprise a second composite region which is formed of a high-value and cost-intensive adhesive. In order to minimize the outlay on materials, the composite region thickness of the second composite region should be as small as possible. To improve the adherent properties, then, the composite region thickness of the first composite region should be greater than that of the second composite region. The second, high-value composite region can portionally have a deficiency of material. In the deficient region, the composite region thickness or caliber of the first composite region can be increased such that the composite region overall has an essentially constant composite thickness.

To have an applicator apply the composite directly to the surface of the body to which the composite material is to adhere, the composite as such is proposed to be carrierless. As a result, the composite can be further processed in-line, i.e., during or immediately after its production, especially in the apparatus for producing the composite, preferably for attachment purposes. Accordingly, no carrier needs to be provided for the composite as such, obviating any need to dispose of a carrier.

The composite can be disposed on a substrate. The composite may comprise the substrate if desired, in which case it is again possible for the composite to be disposed on the substrate in-line, i.e., in one operation together with the production of the composite. The substrate can be, for example, a reelable polymeric or metallic foil or a flat, specifically stackable, length of foil. The composite can in this case be transferred to the surface of the adhered body by, for example, unrolling from the substrate or a comparable deposal from the substrate, for example a release foil. The substrate simplifies off-line usage of the composite, i.e., any usage outside the apparatus for producing the composite, especially after production and/or storage of the composite.

There may further be provided a further composite region on which the first and/or the second composite region are disposed such that the further composite region forms a carrier or substrate for the first and/or second composite region. The substrate may comprise cellulose or a plastic. It may selectively be formed of an organic material or of an inorganic material. For example, the substrate can be formed of silicone paper, of plastic, a polymeric foil, or of any desired release liner, a release liner being any sheet-type protective layer, for instance a release foil or a release paper.

A further advantage of the invention is that a difference in the thermal expansion coefficients of the adhered body, of the composite or of its carrier/substrate can be at least partly compensated via the choice of materials for the composite regions and by adapting and/or spatially varying the composite region thicknesses. In this case, the body can be stored hot or cold without the attached composite becoming wholly or partly detached from the body because of thermal stresses between the mutually contacting components involved.

When the first and second composite regions comprise an adhesive, even a possibly production-based vacancy in the second composite region can contribute to the adherent effect of the composite by virtue of the adhesive effect of the first composite region. The adherent effect of the composite is improved as a result. An adhesive property on the part of the first composite region also causes the second composite region to attach not just to the surface of the adhered body, but also to the first composite region. It can be advantageous here for the adhesive of the second and/or first composite region to be formed of a specifically reactivatable hot-melt adhesive, or hotmelt. The hot-melt adhesive here may comprise base polymers, such as polyamides (PA), polyethylene (PE), amorphous poly-alpha-olefins (APAO), ethylene-vinyl acetate copolymers (EVAC), polyester elastomers (TPE-E), polyurethane elastomers (TPE-U), copolyamide elastomers (TPE-A), vinylpyrrolidone-vinyl acetate copolymers and others. As for the rest, the hot-melt adhesive can contain resins, such as rosin, terpenes and/or hydrocarbonaceous resins, and similarly stabilizers such as antioxidants, metal deactivators and/or photoprotectants, and also, optionally, waxes, such as natural waxes (beeswax) and/or synthetic waxes (wholly synthetic, partly synthetic, chemically modified).

When the composite is intended for use in the food sector, the first and/or second composite region may comprise an adhesive which has a food contact suitability. The adhesive can be of the foil type. In an example of an advantageous configuration for the composite, the first composite region is formed of a hot-melt adhesive, the second composite region is formed of a foil-type adhesive which has a food contact suitability, and the substrate is formed of a polymeric foil, for example in amorphous polyethylene terephthalate (APET). In this configuration, the composite region height or the thickness of the first and of the second composite regions can be between about 5 μm and about 50 μm, preferably the thickness of the first composite region can be between about 10 μm and about 20 μm. The composite region height or the thickness of the second composite region can be about 10 μm. The thickness of the substrate can be between about 5 μm and about 10 μm, preferably between about 15 μm and about 25 μm.

It can be advantageous for one or both of the composite regions to comprise a high-tack hot-melt adhesive, or hotmelt. The high-tack hot-melt adhesive can be based on polyurethane (PU based) or on acrylic, or on a reactive polyurethane (Polyurethane Reactive, PUR) or on a reactive polyolefin (Polyolefin Reactive, POR). Alternatively, one of the other composite regions may comprise a radiation-curable or radiation-crosslinkable adhesive, such as a UV-crosslinkable adhesive (ultraviolet radiation, UV). Varying the composition of the two composite regions makes it possible to ensure that one composite region/side of the composite is faster setting than the other composite region/side of the composite. It is further possible to ensure that one composite region (one side of the composite) is reactivatable—via a (waterborne) solvent, for example—while the other composite region is essentially nonreactivatable (being water-resistant, in particular). The composite regions can also be constituted to each have different melting temperatures. The adhesive used for the first composite region and/or further composite regions can have moisture-crosslinkable or radiation-crosslinkable properties. It can also be chemically crosslinkable. Adhesives used can be permanently tacky or only become tacky on reactivation.

An advantageous design of the composite according to the present invention may provide that the first composite region has a composite region thickness, which is essentially parallel to the third direction and with which the surface-attaching effect of the second composite region is functionally augmented or augmentable. In this case, the composite comprises a (second) composite region formed as a function region and a (first) composite region formed as an effect region. The function region, or to be more precise, the chemical composition of the function region, can be responsible, for example, for the adherent effect of the composite, since the (second) composite region formed as a function region comprises an adhesive. The (first) composite region formed as an effect region can be responsible for the augmentative effect on the adhesive effect emanating from the function region. The thickness of the function and/or effect regions here can be in the range between 0.5 μm and 10 mm.

When the first composite region has for example adhesive properties as well as the second composite region, the similarly adherent first composite region can further support the adherent effect emanating from the second composite region. This is the case in particular when the second composite region is formed of a high-value adhesive which is accordingly applied thin. This thin adhesive region of the composite fails, especially on rough or textured surfaces as found on stonework, wood, some cardboards or glasses, to penetrate into the surface structures, weakening the adherent effect. The augmentation due to the first, likewise adherent composite region improves the adherent effect. The first composite region here performs a filling function to fill the regions in the textured or rough surface such that even the second composite region with its high-value adhesive can penetrate into the surface unevennesses and develop an adhesive effect there. The filling effect due to the first composite region helps to achieve a positive or substantially positive contact between the surface and the second composite region even in uneven places on the surface.

The first or second composite region can have a barrier effect with regard to whichever is the other composite region; more particularly, one of the composite regions, or at least portions of this composite region, can form a barrier layer. The barrier effect may, for example, take the form of a composite region which comprises a water-soluble adhesive being shielded from the adhesive-dissolvingly active atmospheric humidity of the ambient air by the barrier effect of whichever is the other composite region.

In a possible advantageous embodiment, the adherent properties of the composite to the surface of a body are influenceable by the first and/or the second composite region being formed of a material whose composition is adapted to the material forming the surface of the body, wherein the adherent properties comprise the strength of adherence, the rate of adherence, the adherence formation pressure, the adherence duration, the adherence outlay and/or the redetachability of the composite. The adherence properties can be manipulated via different formulations for the constituents of the composite regions, especially for the (hot-melt) adhesives in the composite regions.

In the interests of a method of making which is efficient for the required composite dimensions and also cost-effective, the first and the at least second composite regions are each extruded or extrudable in a two-dimensional manner. Preferably, the first and second composite regions are both co-extruded or co-extrudable. Two-dimensional extrusion can be obtained with, for example, a wide-slot extrusion die into which the materials of which the composite regions of the composite are formed are introduced in molten form. Selectively, a multiple extrusion die or a co-extrusion die can be used, the constituents of both/all of the composite regions being conjointly melted and conjointly extruded, i.e., co-extruded. In co-extrusion, for example, a viscid stream comprising a plurality of different materials, more particularly comprising two different hot-melt adhesives, can be directed onto an optionally coolable transporting device or onto a substrate whereon and whereto the extrudates at least partly or regionally harden or, respectively, adhere if they contain adhesives, and are inactivated, if appropriate. The (co-)extrudates can be made very thin and hence in a material- and cost-saving manner.

In a possible embodiment, at least the first composite region is formed as a layer of the composite, said layer having a sheetlike extent which is in an essentially parallel orientation to the sheetlike extent of the composite and which is preferably essentially equiareal to the two-dimensional extent of the composite. Selectively, the second composite region can also be at least portionally built up on the first composite region, rendering the composite at least portionally multilayered. The composite region thickness of the first and/or of the second composite region can vary at least portionally along the first direction and/or along the second direction.

In this embodiment, the layer of the first composite region and the layer of the second composite region can each have, at least portionally, a first layer thickness and a second layer thickness. The sum total of the layer thicknesses of the layers can correspond for instance to not more than the composite thickness in the sense of the maximum composite thickness of the entire composite.

Preferably, the composite can be characterized by two or more, specifically sheetlike or stripy, portions in which the first and the second composite regions mutually adjoin along an interface. One possible embodiment here can provide that the portions form an essentially regular pattern where a first portion or a first group of portions have an essentially constant separation from at least one second portion or from at least one second group of portions along the first direction and/or along the second direction. For example, the second composite region of the composite or, respectively, the second layer of the multilayered composite may accordingly comprise one or more interruptions parallel to the first direction and/or parallel to the second direction. The interruptions can reduce the material requirements and hence the fabrication costs. These interruptions to the second composite region (or to the second layer) create a composite wherein the second composite region is disposed on the first composite region (or on the first layer) in accordance with a pattern characterized by the interruptions. The interruptions can be disposed equidistantly; optionally, the interruptions themselves can be formed in accordance with a pattern. This subdivides the entire composite into portions in a regular manner where the composite has a single- or multi-layered construction.

When the second composite region, provided with spatial interruptions in a regular manner, comprises an adhesive, the composite material will have adhesive properties only where there is no interruption or, respectively, where the composite has a multilayered portion. It can be advantageous here for the interruption(s) to be preferentially disposed in one direction such that the multilayered portions disposed in adjacency to the interruptions form web-shaped portions of the composite. Since, according to the present invention, the second composite region comprises an adhesive, the portions bounded by the interruptions and/or the web-shaped regions of the composite form those regions which are preferentially involved in the adherence of the composite. The first composite region here can have an adherence-augmenting function to improve the adherence properties also on, for example, rough surfaces.

In addition to the portionally multilayered composite, the present invention provides numerous alternatives with which the properties of the adherent bond which are desired for the particular field of use—such as, for instance, bond strength, bond durability, bond formation rate and/or a desired rereleaseability of the adherent bond—are likewise improved in accordance with the intended use. Thus, the interface along which the composite regions adjoin each other within one or more portions of the composite can extend essentially parallel to the composite face, at least regionally. In this case, the two-dimensional composite regions preferably lie on top of each other, considered horizontally; the composite has at least portionally a layered/multilayered construction.

Alternatively, the interface along which the composite regions adjoin each other within one or more portions of the composite can at least regionally be essentially perpendicular to the composite face. In this case, the horizontal view, i.e., the view of the horizontally extending composite, shows the composite regions to be portionally side by side. Only a view of a vertically extending composite will create the impression that the composite is multilayered with layers being formed alternatingly of the first composite region and of the second composite region.

It may be preferable for the interface along which the composite regions adjoin each other within one or more portions of the composite to comprise at least one angled region. More particularly, the course of the interface can have a U-shaped cross section. In this case, a horizontal view of the cross section through the composite will show a region of the second composite region to lie within a region of the first composite region. The second composite region is accordingly embedded at least regionally in the first composite region in every portion of the composite. The composite face in this may be essentially planar. Alternatively, the composite face can have angles in the region of the portions whereby the second or first composite region protrudes portionally out of the composite face or into the composite face. In this case, the effective area of direct contact between the composite and the surface of the body to which the composite is to attach is smaller than the composite face (portionally provided with angles). This can be advantageous in the case of redetachable composites.

It is further possible for the interface along which the composite regions adjoin each other within one or more portions of the composite to be at least regionally curved. The curvature of the interface can be essentially convex or concave.

A further embodiment of the composite according to the present invention is characterized by an external composite region disposed such that the first and the second composite regions are disposed between the external composite region and the substrate. The external composite region can be disposed on the second composite region in an at least portionally adherent manner. The disposition can be effected mechanically, for example via a roller or pressing/printing apparatus. More particularly, the disposition can be effected in-line, i.e., during the production of the composite, i.e., within the apparatus for producing the composite. The outer composite region can be formed of a fibrous material, making the composite useful as a wall or ceiling covering, for example.

With regard to improving the recoverability of bodies to which the composite of the present invention is intended to attach, a further version of the invention comprises a composite as defined in claim 18. So the composite serves to create a specifically durably adherent bond between at least one first material and at least one second material. This comprises, for example, the bond between two bodies which are each made of different materials. The first composite region of the composite adheres to the first material and the second composite region adheres to the second material. According to the present invention, the composite regions of the composite after creating the bond between the two materials are separable such that the materials to which the composite regions adhere have, following the separation of the composite regions, a varietal purity sufficient for recovery of the materials.

After the composite regions have been separated, the first composite region is left on the first material and the second composite region is left on the second material. The materials forming the first and second composite regions are adapted to the materials forming the bodies. It is accordingly possible for the materials forming the bodies to be recoverable because of their high varietal purity due to the adaptation of the materials forming the composite regions. Costly and inconvenient separation of the materials forming the bodies from the constituents of the composite is obviated. The attainable degree of varietal purity is about 99% or thereabove.

It is advantageous for the composite to comprise an activatable effectuant whose activation causes the separation of the composite regions to be effectuated. The effectuant can be disposed in the region of the interface between the composite regions of the composite. There may preferably be a boundary layer which comprises the effectuant and which is disposed in the region between the first composite region and the second composite region.

The effectuant can be activatable by changing the energy balance of the effectuant. For instance, the activation may be effected by an input of energy into the effectuant, in particular by electric energy, thermal energy, radiative energy, sonic energy or combinations thereof. More particularly, infrared radiation (IR radiation), electric current, electric voltage, ultrasound, supercooling or heating may be provided for activation. Individual measures of this kind or combinations thereof can lead to the effectuant transferring a mechanical effect on the composite regions to render these separable. The mechanical effect can include mechanical stresses or strains. However, activating the effectuant may also induce a chemical reaction which causes the composite regions to separate from each other.

Because the composite of the present invention is in all its above-described embodiments adherently disposable on a surface of a body in a predetermined material such that the properties of the adherent bond which are desired for the particular field of use—such as, for instance, bond strength, bond durability, bond formation rate and/or a desired rereleaseability of the adherent bond—are unreservedly available, the composite is alternatively useful for labeling or as labeling aid. The invention accordingly also comprises the aspect that the composite forms a label or labeling aid useful for labeling or identifying the body to whose surface the composite is attachable. The body may be, for example, a packaging article formed of paper, cardboard, metal, plastic, glass or any other desired materials or combinations of these or other materials. However, the body may also be a product or a product housing whereon a label or caption is to be adhesively disposed.

The adherent properties of the second composite region and because printing and/or writing can be applied to the composite, preferably to the first composite region, mean that the body on whose surface the composite is adherently disposed can be labeled. Depending on the constitution of the second (adherent) composite region and/or of the first (strongly adherent or weakly adherent) composite region or depending on the formulation of the constituents of the second and/or first composite regions, the labeling, or the material used for labeling, can attach strongly and durably or be redetachable. The material used for labeling can selectively be transparent, opaque/translucent or nontransparent. Alternatively, printing or writing can have been applied to the composite on the composite face or on the face which is opposite the composite face. The printing or writing can extend to one composite region or to two or more composite regions. The writing or printing can alternatively also be disposed on a substrate or carrier comprised by the composite.

It can also be provided that a material specifically useful for labeling or identification can be applied to the composite to cause the composite to serve as adherent for the material attachable to the surface of the body. The material/label can be formed for example of a polymeric or metallic foil, or of a paper or a cellulosic material. The designs of the composite, i.e., the compositions, constitutions and dispositions of the composite regions of the composite relative to each other and within the composite are adjustable to the properties and constitutions of the surface of the label and of the adherend surface of the body/packaging article.

It is advantageous with regard to the assembly, storage, transportation or further processing of the composite according to the present invention when the composite can be wound up on a cylinder or roll or unwound off a cylinder or roll. Turning the cylinder or roll is an easy way to detach regions or portions of the composite and apply them to the adherend body.

There are further aspects of the invention where the composite described at the beginning is of additional relevance for applications in the packaging industry. It is customary in the packaging arts for the covering foil of a plastic tray packaging article comprising a PET outer layer about 15 μm to about 25 μm in thickness to be laminated via a pressure-sensitive adhesive (PSA) of about 20 μm with a polyethylene layer (PE layer) about 15 μm in thickness. When the packaging article is, for example, a plastic tray with a covering foil, the usually thermoformable tray material, which must accordingly be made thicker in caliper, consists in the prior art of an about 300 μm to about 400 μm PET layer on the outside and of a 15 μm PE layer on the inside. The covering foil likewise comprises a PE layer, which is heat-sealable to the PE layer of the tray material. A high-tack adhesive (e.g., PSA, about 20 μm in thickness) is situated according to the prior art between the PET layer and the PE layer. The food item only comes into contact with the PE layer. Packaging articles of this type have become established because of the heat-sealability of the PE layer in particular in that it made it possible to achieve an airtight closure. The prior art accordingly requires costly and inconvenient processes to create a packaging article which is airtightly closeable by heat sealing.

This is the point of departure for essential aspects of the invention to propose the use of the composite described at the beginning as a packaging article in accordance with claim 28 and a process for producing a packaging article in accordance with claim 32.

A method is accordingly provided to use the composite described at the beginning as a packaging article or as a packaging article constituent. A method of using the composite of the present invention as a food packaging article or as a food packaging article constituent is particularly preferred.

Using the composite of the present invention for packaging purposes, especially for food packaging articles, saves appreciable quantities of material and operations. By using an adhesive which is approved for food contact and which can be applied in a very thin layer, the invention provides a way to close packaging articles airtightly without using any PE whatsoever. This is particularly advantageous in that the approved food contact adhesives hitherto used cannot be two-dimensionally adhered using a PE outer layer.

The invention also proposes to bond the approved food contact adhesive layer on the reverse side with a PSA adhesive so that the adhesive layer is firmly bondable via the PSA layer to the PET layer in an adherent manner. Application is by co-extrusion. Two different types of adhesive are bonded to each other by preferably being introduced into the nip between two rollers with a falling curtain of extrudates in the form of molten liquids, for example. One of the rollers is at this stage partially wrapped by the PET foil. This makes it possible for the packaging article underside to consist exclusively of about 300 μm to about 400 μm PET. After thermoforming, the PET of the underside is bondable to the novel adhesive on the lid foil inside surface by a specifically thermal input of energy in a manner comparable to a heat-sealing operation. This is because the heat-sealing temperatures are distinctly above the temperatures involved in producing the composite by extrusion. For instance, extrusion temperature can be between about 120° C. and about 150° C., while the sealing temperature is more like above about 200° C.

The packaging article of the present invention comprises a first packaging article constituent and at least a second packaging article constituent. The packaging article constituents bound at least portionally one or more preferably airtightly sealed cavities to accommodate the packaged contents. According to the present invention, the first packaging article constituent and/or the second packaging article constituent is formed of a composite described at the beginning. The first and the second packaging article constituents are at least portionally in contact with each other to form at least one contact face as well as one or more preferably airtightly sealed cavities to accommodate the packaged contents. The first packaging article constituent and the second packaging article constituent are bondable or bonded to each other by specifically thermal input of energy in the region of the contact face.

Optionally, the composite may comprise a substrate composed of a polymeric foil, especially a polyethylene terephthalate foil (PET foil). The PET may comprise amorphous PET (APET). The first composite region of the composite may comprise a hot-melt adhesive. The second composite region of the composite may comprise an adhesive which has a food contact suitability and which is preferably of the foil type. Preferably, the second packaging article constituent, for example the tray or the tray-type bottom part of a multi-part plastics packaging article, is formed of a polymeric foil, especially a polyethylene terephthalate foil (PET foil). The second packaging article constituent may also comprise a polymeric foil, especially a polyethylene terephthalate foil (PET foil).

The present process for producing a packaging article comprising a first packaging article constituent and at least a second packaging article constituent in a manner wherein the packaging article constituents bound at least portionally one or more preferably airtightly sealed cavities to accommodate the packaged contents provides that the first packaging article constituent and/or the second packaging article constituent is formed of a composite as described at the beginning and as according to the present invention. The first and the second packaging article constituents are at least portionally brought into contact with each other to form at least one contact face as well as one or more preferably airtightly sealed cavities to accommodate the packaged contents. The first packaging article constituent and the second packaging article constituent are bonded preferably airtightly to each other by specifically thermal input of energy in the region of the contact face. For example, supplying a thermal energy which is similar to the input involved in heat sealing will cause the adhesive of the composite of one of the packaging article constituents to melt and to bond to the other packaging article constituent or to components of the other packaging article constituent.

It may be provided that the first and/or second packaging article constituent formed of the composite is formed by co-extrusion of the composite regions onto a substrate. Alternatively, the first composite region can be formed of an adhesive which has a food contact suitability and is preferably of the foil type. The second packaging article constituent can be thermoformed from a polymeric foil, especially a polyethylene terephthalate foil (PET foil).

The aforementioned parts to be used according to the present invention, the claimed parts to be used according to the present invention and the parts to be used according to the present invention which are described in the exemplary embodiments are not subject to any special exceptional conditions in respect of their size, shape, choice of material and technical conception, so the familiar selection criteria in the field of application can find unreserved application.

Further details, features and advantages of the subject matter of the invention will be apparent from the dependent claims and also from the description hereinbelow and the related drawing which depicts, by way of example, an exemplary embodiment of a composite and also of a packaging article. Even individual features of the claims or embodiments can be combined with other features of other claims and embodiments.

### BRIEF DESCRIPTION OF THE FIGURES

In the drawing

FIG. 1 shows a detail of a two-layered composite in a schematic side view,

FIG. 2 shows a detail of an essentially two-layered composite in a schematic perspective view,

FIG. 3 shows a schematic sectional view of a composite having composite regions which portionally differ in thickness,

FIG. 4 shows a schematic sectional depiction of an alternative composite having composite regions which portionally differ in thickness,

FIG. 5 shows a (schematic) sectional side view of a portionally two-layered composite,

FIG. 6 shows a composite having regularly disposed groups of composite region portions in lateral section (schematic),

FIG. 7 shows a composite in lateral section wherein the composite regions are in alternating side-by-side disposition (schematic),

FIG. 8 shows a composite in lateral section (schematic) wherein the second composite region is portionally disposed within the first composite region such that the composite face has a planar course,

FIG. 9 shows a composite in lateral section (schematic) wherein the second composite region is portionally disposed within the first composite region such that the composite face has angled regions protruding toward the outside,

FIG. 10 shows a composite in lateral section (schematic) wherein the second composite region is portionally disposed within the first composite region such that the composite face has angled regions protruding toward the inside,

FIG. 11 shows a composite in lateral section (schematic) wherein the second composite region is portionally disposed within the first composite region such that the interface between the composite regions is portionally curved,

FIG. 12 shows a body in a schematic perspective view whereon a portionally multilayered composite is disposed in an adherent manner,

FIG. 13 shows a four-ply composite having a substrate and an external composite region in a schematic sectional depiction,

FIG. 14 shows a schematic sectional depiction through a three-layered composite having a substrate,

FIG. 15 shows a schematic depiction of a packaging article in a sectional view, and

FIG. 16 shows a schematic depiction of a composite having a boundary layer comprising an effectuant.

### DETAILED DESCRIPTION OF EXEMPLARY EMBODIMENTS

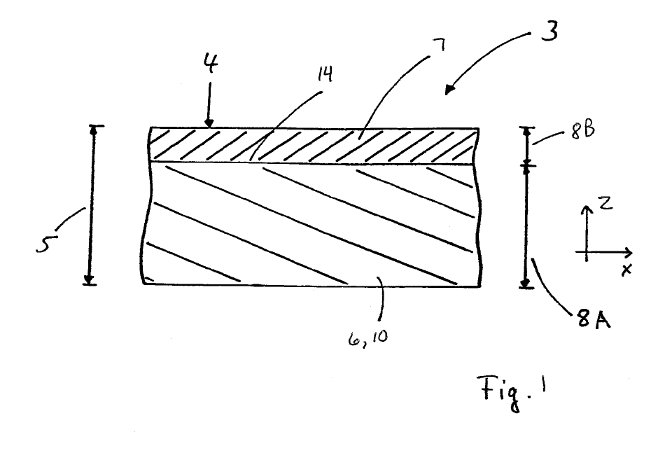

FIG. 1 in a schematic manner reveals a composite 3 which is attachable, specifically adhesive, to a surface of a body such as, for instance, a packaging article or a housing and has a sheetlike extent, a composite face 4, extending in a first direction x and in a second direction y, said second direction being essentially perpendicular to the first direction x, and having a composite thickness 5 which extends into a third direction z, which is essentially perpendicular to the composite face 4. The composite 3 is formed of a first composite region 6 and a second composite region 7, which at least portionally adjoins the first composite region 6. The second composite region 7 has adherent properties so that the composite 3 is attachable, especially redetachably attachable, with the composite face 4 to a surface of a body.

FIG. 1 shows the composite to be carrierless. The first composite region 6 of the composite 3 has adherent properties. Especially the second composite region 7 comprises an adhesive. The adhesive can be formed for example of a reactivatable hot-melt adhesive. The first composite region 6 has a composite region thickness 8A which is essentially parallel to the third direction z and with which the surface-adherent effect of the second composite region 7 is functionally augmented. The adherence properties of the composite 3 on the surface of the body are optimized in that the second composite region 7 is formed of a material whose composition is adapted to the material forming the surface 1 of the body 2. The adherence properties comprise the strength of adherence, the rate of adherence, the adherence formation pressure, the adherence duration, the adherence outlay and/or the redetachability of the composite 3. With regard to the production of specifically very thin composite regions 6, 7 the first composite region 6 and the second composite region 7 are advantageously extruded in a two-dimensional form. Co-extrusion is useful for inexpensive production of composite 3 when both composite regions 6 and 7 are extruded.

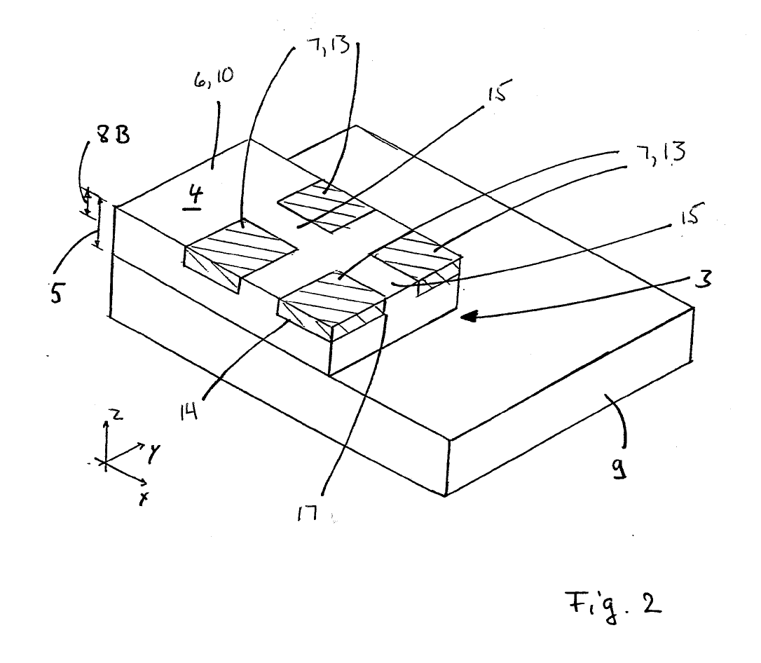

FIG. 2 reveals a schematic perspective view of a composite 3. The composite 3 is shown therein to be disposed on a carrier or a substrate 9. FIG. 2 also reveals that the first composite region 6 is formed as layer 10 of composite 3. The layer 10 has a sheetlike extent which is essentially parallel to the sheetlike extent of composite 3. The layer 10 is essentially equiareal with the two-dimensional extent of composite 3. The constitution of composite 3 depicted in FIG. 2 is such that a label can be applied to composite 3 to cause composite 3 to serve as adherent for the label attachable to the surface of the body.

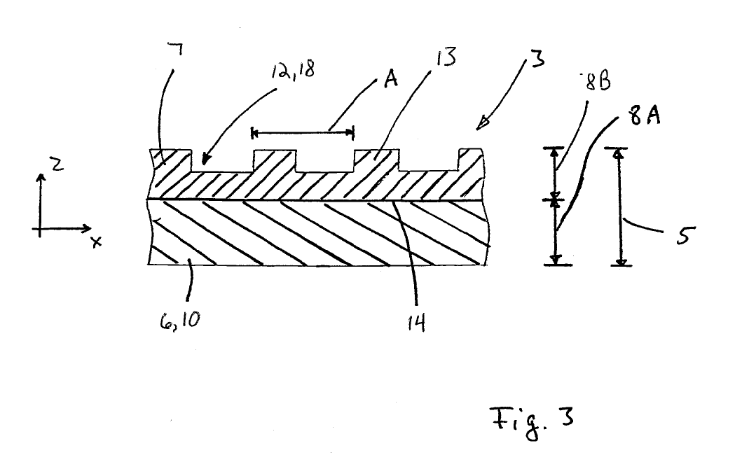

FIG. 3 reveals, at least schematically, a vertical section through a composite 3 of alternative execution. The second composite region 7 is shown therein to be built up on the first composite region 6, rendering the composite 3 multilayered across the full composite width (and optionally also across the full composite length). FIG. 3 also reveals that the composite region thickness 8 of the second composite region 7 varies portionally along the first direction x. In the places where the second composite region 7 has a deficiency 12 with regard to the composite region thickness 8B, the sum total of the composite region thicknesses 8A and B corresponds at most to the composite thickness 5 of composite 3; in FIG. 3, it is less than the composite thickness 5. In those places where the second composite region 7 has no deficiency 12, the sum total of the composite region thicknesses 8 corresponds to the composite thickness 5.

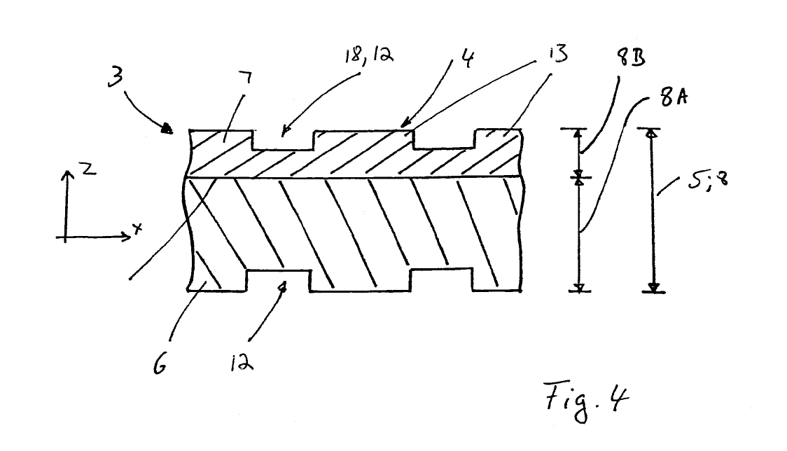

FIG. 4 shows—likewise schematically—a composite 3 wherein the second composite region 7 is built up on the first composite region 6 such that the composite region thickness 8 of the first and second composite regions 6 and 7 varies portionally along the first direction. Both the composite regions 6 and 7 accordingly have deficiencies 12. According to FIG. 4, the deficiencies 12 of the first composite region 6 are disposed opposite the deficiencies 12 of the second composite region 7. Alternatively, the deficiencies 12 of the first composite region 6 can have an offset in the first direction or in the second direction (x, y), which is not depicted in FIG. 4.

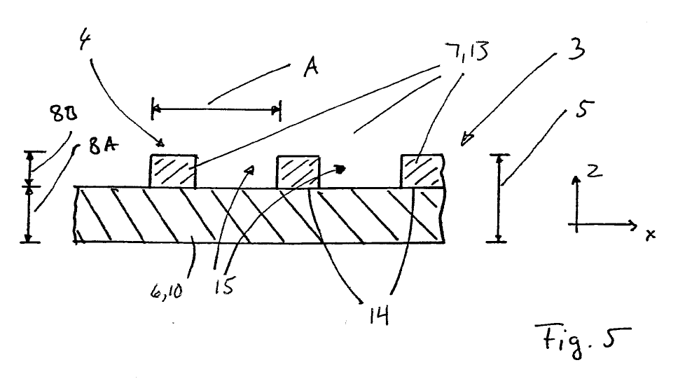

FIG. 5 likewise shows a section in the vertical direction (z) through a composite 3 having a first, layer-type composite region 6 and a second composite region 7. The composite 3 of FIG. 5 has a plurality of stripy portions 13 in the second composite region 7 in each of which the first and second composite regions 6 and 7 adjoin each other along an interface 14. Alternatively, the portions 13 can extend across a larger region in the first direction x, which would make the portions less stripy but, on the contrary, sheety (not depicted in FIG. 5). FIG. 5 reveals that the interface 14 is essentially parallel to the composite face 4.

FIG. 5 shows that the composite thickness 5 in the region of portions 13 is formed by the sum total of the composite region thicknesses 8 of the first and second composite regions 6 and 7. Therefore, the composite thickness 5 corresponds portionally to the sum total of the composite region thicknesses 8. The second composite region 7 has interruptions 15 between the portions 13 where the second composite region 7 has a composite region thickness 8 of about 0 μm. FIG. 5 shows that the portions 13 form an essentially regular pattern wherein a first portion 13 has an essentially constant separation A from a second portion 13 along the first direction x.

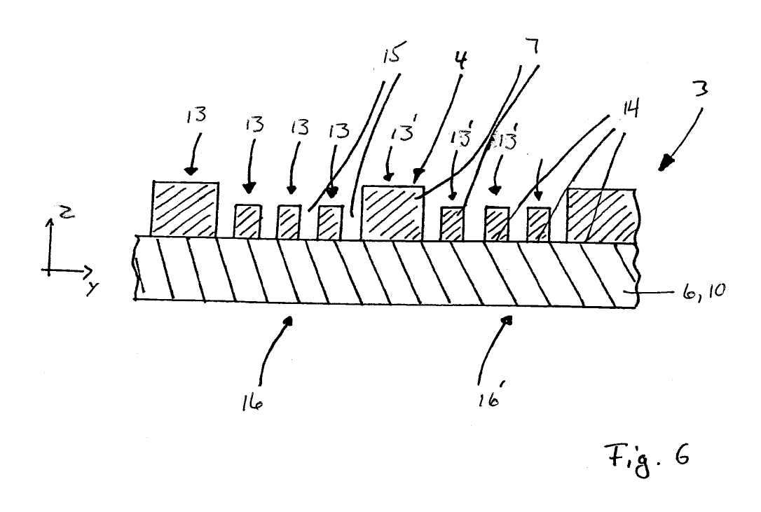

FIG. 6 reveals a composite 3 having a second composite region 7 having a group 16 of portions 13. The portions 13 are shown therein to form an essentially regular pattern wherein a first group of portions 16 have an essentially constant separation from at least one second group of portions 16′ along the first direction x. The second composite region 7 has interruptions between both the portions 13 and between both the groups of portions 16 and 16′. Alternatively, material deficiencies can also be provided instead of the interruptions.

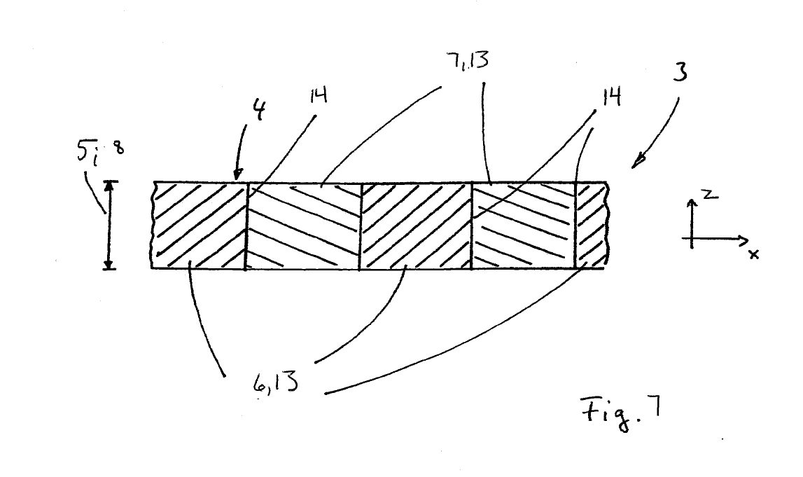

FIG. 7 shows a vertical section through a composite 3 having an alternative disposition of composite regions 6 and 7. According to FIG. 7, the composite regions 6 and 7 are portionally disposed such that the interfaces 14 extend essentially vertically, i.e., along the second direction y. Each interface 14 is essentially perpendicular to the composite face 4. The result is the alternating formation of portions in which the first and second composite regions 6 and 7 are disposed side by side and adjacent to each other along the first, horizontal direction x. The composite thickness 5 is shown by FIG. 7 to correspond to the composite region thickness 8 of the first and/or second composite region 6, 7.

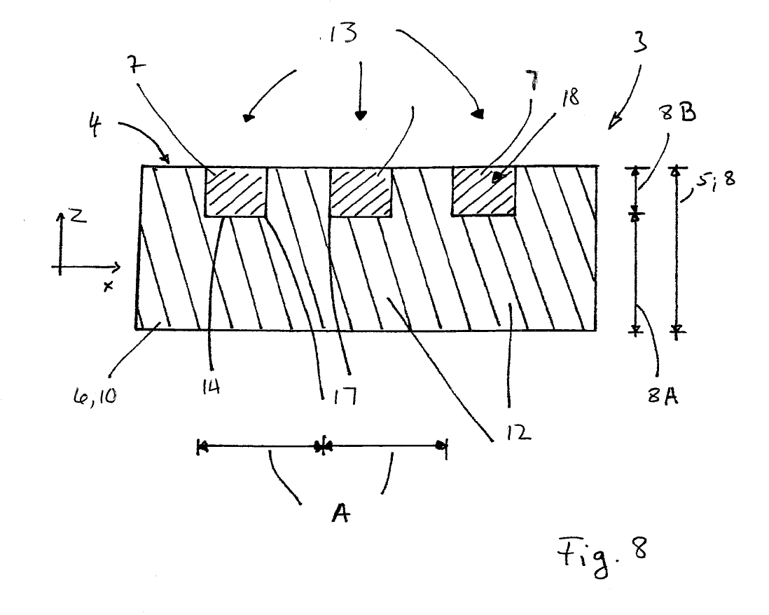

FIGS. 8 to 10 reveal composites 3 wherein the interfaces 14 have angled regions 17. According to FIGS. 8 to 10, the interfaces 14 each have a U-shaped cross section.

FIG. 8 shows portions 13 in which the first composite region 6 has deficiencies 12 of material. Within these deficiencies 12 of the first composite region 6, the second composite region 7 is disposed such that a regular pattern of the two composite regions 6 and 7 is formed along the first direction x. The composite face 4 of the composite is shown in FIG. 8 to form a plane which is portionally composed of regions of the first and of the second composite region 6, 7. In portions 13, the second composite region 7 is embedded within the first, layer-type composite region 6. The composite thickness 5 in the portions 13 is formed by the sum total of the composite region thicknesses 8 of the composite regions 6 and 7. Elsewhere, i.e., in the regions of the composite face 4 which are adjacent to the portions 13, the composite thickness 5 corresponds to the composite region thickness 8 of the first composite region 6.

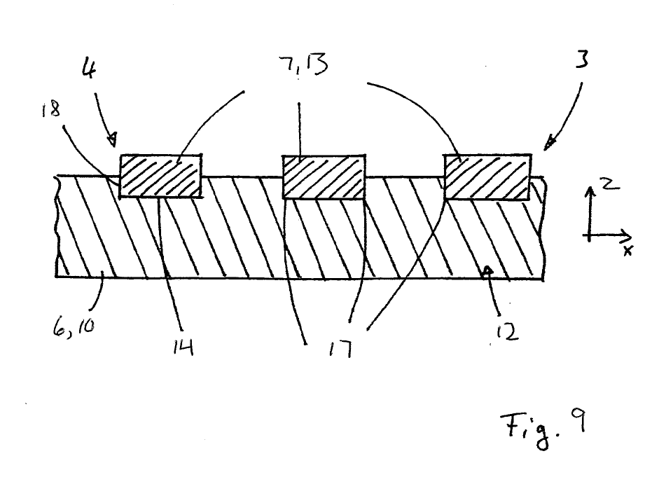

According to FIG. 9, the composite thickness in the portions 13 corresponds at least to the sum total of the composite region thicknesses of the first and second composite regions 6 and 7. In the regions which are adjacent to the portions 13, i.e., wherever the second composite region 7 has an interruption, the composite thickness is greater than the composite region thickness of the first composite region 6. In the portions 13, the second composite region 7 protrudes out of the composite face 4, so the composite face 4 does not form a planar surface but rather has a texture. The texture is characterized by the pattern-type disposition of the portions 13 of the second composite region 7. Given an appropriate constitution of the (contact) faces (1, 4) involved, the texture enables better adaptation, if necessary, of the composite face 4 to the surface of the adherend body.

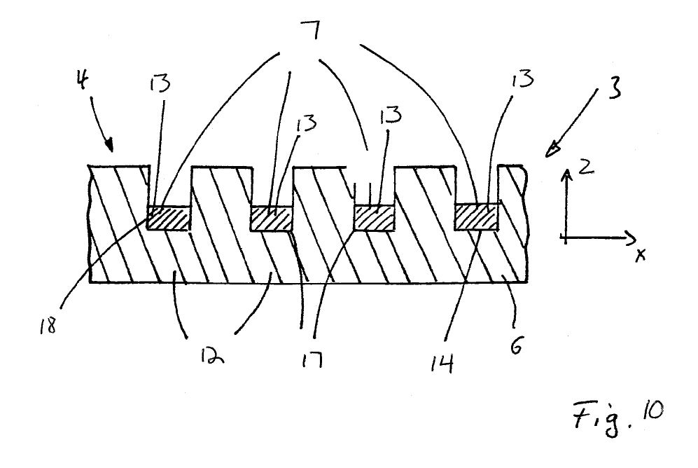

FIG. 10 likewise shows a vertical section through a composite 3. In the portions 13, the sum total of the composite region thicknesses of the first and second composite regions 6 and 7 is less than the composite thickness, so the composite face 4 has recesses 18 in the portions 13. The recesses 18 are disposed within deficiencies 12 of the first composite region 6. Between the deficiencies 12 of the first composite region 6, i.e., in the regions adjacent to the portions 13, the composite thickness corresponds essentially to the composite region thickness of the first composite region 6. The recesses 18 likewise endow the composite face 4 of FIG. 10 with a textured surface which permits better adaptation to the surface 1 of the adherend body 2.

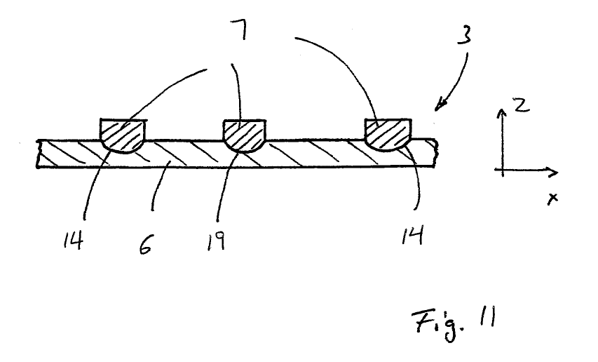

FIG. 11 reveals a sectional view of a composite 3 having an at least regionally curved interface 14. The curvature 19 of the interface 14 is depicted therein to have a crowned/concave profile in cross section; that is, the curvature 19 is disposed such that the interface 14 protrudes into the first composite region 6. What is not depicted in FIG. 11 is an interface 14 having an at least portionally convex or bulbous curvature 19 which protrudes out of the first composite region 6 and into the second composite region 7.

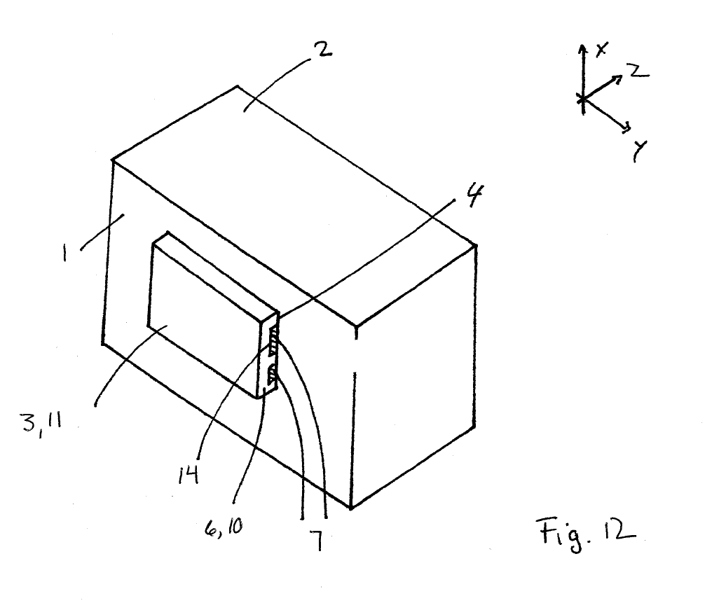

FIG. 12 shows a schematic and perspective view of a body 2 on whose surface 1 a composite 3 is adherently disposed as label 11. The composite 3 used as label 11 serves to label or identify the body 2. The body 2 can be, for example, a packaging article or a housing of an instrument. The label 11 draws a user's attention, for example, to the contents of the packaging article or the properties of the instrument. It is accordingly advantageous for printing or writing to have been applied to the composite 3. If the packaging article is to be repeatedly reused, it can be advantageous for the label 11 to be redetachable.

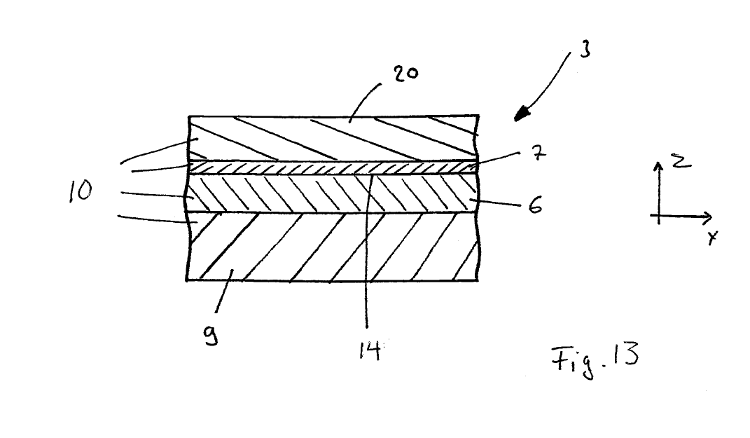

FIG. 13 reveals a schematic depiction of a four-ply composite 3. The second composite region 7, comprising an adhesive for example, has a (preferably non-adhesive) outer composite region 20 disposed on it. The first composite region 6 disposed underneath the second (adhesive) composite region 7 is adherently disposed on a substrate 9, for which the first composite region advantageously also comprises an adhesive. The substrate 9 can be, for example, a release liner or a polymeric foil. The external composite region 20 can be formed, for example, of a fibrous material, making the composite 3 of FIG. 13 useful for a fibrous wallpaper. More particularly, printing can be applied or applicable to the external composite region 20, rendering the composite 3 alternatively useful for labeling a body 2 (not depicted in FIG. 13).

The composite 3 of FIG. 13 is obtainable, for instance, by applying the first and second composite regions 6 and 7 to the substrate 9 in the form of liquid melts of hot-melt adhesives by co-extrusion, i.e., the two hot-melt adhesives are extruded through one die suitable for conjoint extrusion. It can be advantageous here for the substrate 9 to be cooled, at least portionally. The hot-melt adhesives have different formulations/adhesive constituents, such that the adherence of the first composite region 6 on the substrate 9 is particularly advantageous. The external composite region 20 is preferably disposed mechanically, but especially in-line, i.e., immediately following co-extrusion, within the apparatus for the extrusion. The external composite region 20 adheres to the second composite region 7, and the formulation of the adhesive in the second composite region 7 is optimized for adherence to the external composite region 20. The adherence of the external composite region 20 can for example be simplified and/or improved by the action of one or more rollers exerting a mechanical pressure on the composite 3.

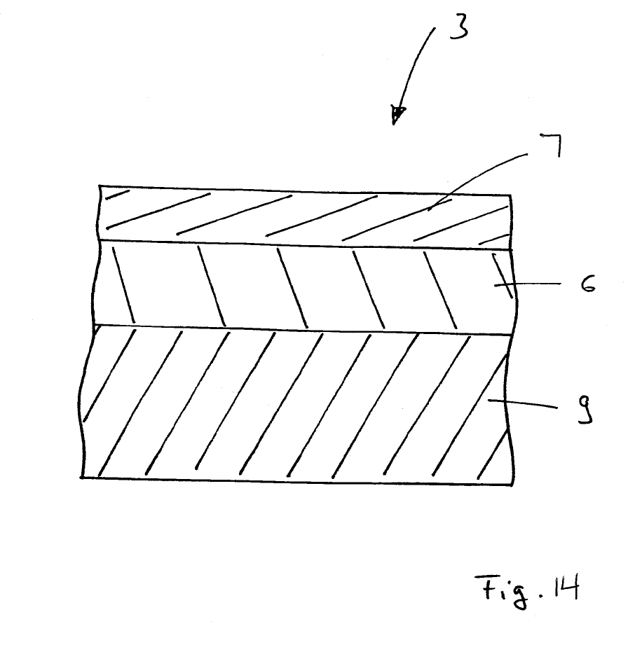

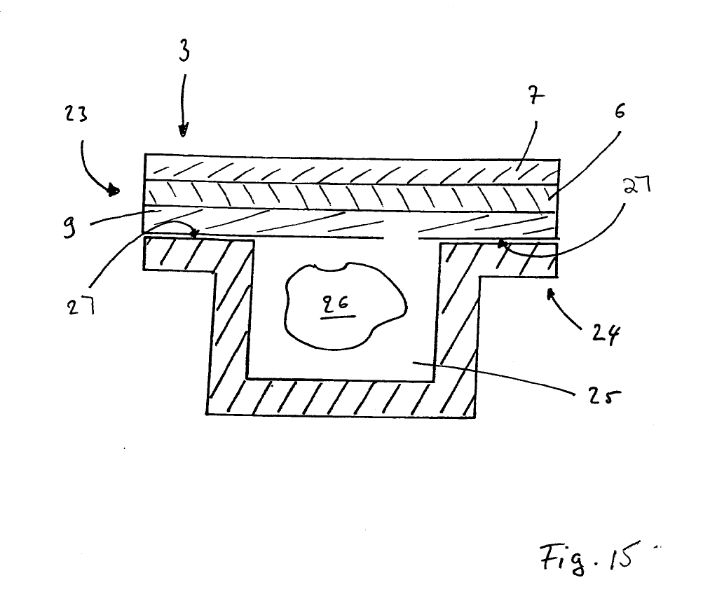

FIG. 14 reveals a further version of the composite according to the present invention, this alternative being useful in the packaging arts for example. A section through the overfoil of a packaging article is schematically depicted therein, while the packaging article is schematically imaged in FIG. 15. The overfoil of FIG. 14 comprises a first composite region 6 formed of a hot-melt adhesive, for example of a pressure-sensitive adhesive (PSA). The composite region 6 can have a thickness of about 10 μm to about 20 μm, for example. The composite region 6 is disposed on a substrate 9 which consists of an amorphous polyethylene terephthalate foil (APET foil) having a caliber of, for example, about 15 μm to about 25 μm. The second composite region 7, which for example can consist of a foil-type adhesive having a thickness of about 10 μm, is disposed on the first composite region 6. The foil-type adhesive of the second composite region 7 is suitable for contact with food items.

A packaging article specifically for packaging food items is discernible in a schematic form from FIG. 15. The packaging article comprises a first packaging article constituent 23 formed as overfoil. The overfoil was already detailed in FIG. 14. The overfoil is disposed on a second packaging article constituent 24 formed as underfoil. The underfoil 24 can be thermoformed into a tray-type shape. It can consist of an APET foil having a layer thickness of about 250 μm to about 400 μm. A cavity 25 forms to accommodate the packaged contents 26, especially the packaged food items. Contact faces 27 are formed on the sides of the underfoil 24 where there is some contact or at least a support surface between the overfoil and the underfoil 24. After the thermoformed tray 24 has been covered with the overfoil, thermal energy can be supplied to the packaging article in the region of contact area 27 to cause a temperature increase comparable to the temperature change used in the heat sealing of plastics packaging. The foil-type adhesive of the second composite region 7 melts in the process and bonds to portions of the second packaging article constituent 24 in the region of contact area 27. This bonding leads to an airtight enclosure of contents 26 in the packaging article.

Because the packaging article of FIG. 15 with the overfoil of FIG. 14 does not comprise a polyethylene layer (PE layer), it is distinctly less costly to produce than is currently the case in the art. In addition, the packaging article constituents of FIGS. 14 and 15 are simpler to recycle/recover, since they are formed of fewer materials having to be separated for recovery.

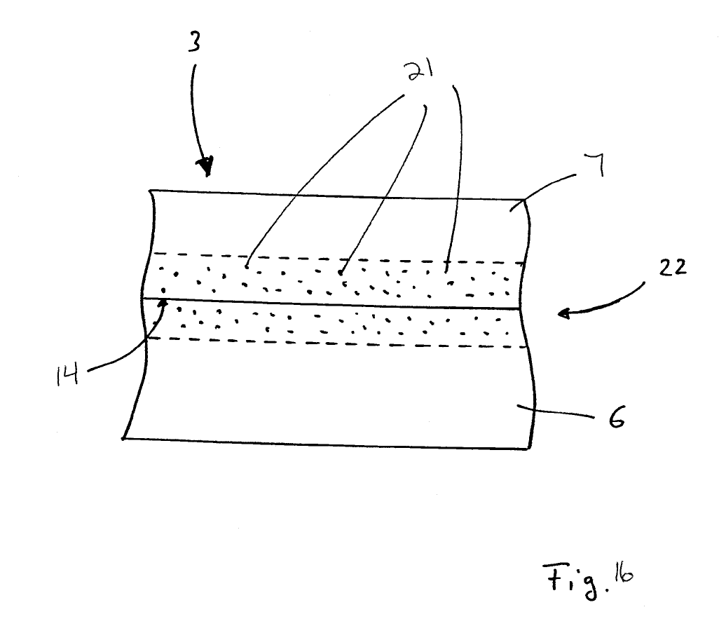

FIG. 16 reveals a schematic view of a composite 3 for adhering different materials which is simple to fabricate with a view to the recovery of these different, mutually adhered materials. The composite 3 of FIG. 16 comprises a first and second composite region 6 and 7 which are constituted such that by type and material they are properly adapted to the adherend materials (not depicted in FIG. 16). An effectuant 21 is disposed in a boundary layer 22 within the region of the interface 14 between composite regions 6 and 7. The effectuant 21 is activatable and effectuates a varietally pure separation of the adherend materials with a view to their recovery. Activation of effectuant 21 is for example by an input of energy, for instance by infrared radiation (IR radiation), by ultrasound, by electric current or by other measures that affect the energy balance of the effectuant. Activating the effectuant 21 in the composite 3 causes the composite regions 6 and 7 to separate from each other. Hence an activation of effectuant 21 causes the composite 3 to split into its composite constituents formed by the composite regions 6 and 7.

Activating the effectuant 21 specifically in the boundary layer 22 and the subsequent separation of composite 3 also causes the materials adhered to composite 3 to be separated from each other. Separation of the materials bonded adherently to composite regions 6 and 7 leaves the first material stuck to the first composite region 6 and the second material stuck to the second composite region 7. Since the composite regions 6 and 7 are adapted to the different materials, the materials after their separation have a very high varietal purity which can be above 99%. This accordingly avoids that loss of quality which might result because necessary separation of materials for recovery leaves behind a separated material which, for example by other types of adhesives, is so contaminated that its varietal purity is too low for recovery.

### LIST OF REFERENCE SIGNS

| | |
|---|---|
| 1 | surface |
| 2 | body |
| 3 | composite |
| 4 | composite face |
| 5 | composite thickness |
| 6 | first composite region |
| 7 | second composite region |
| 8A, 8B | composite region thickness |
| 9 | substrate |
| 10 | layer |
| 11 | label |
| 12 | deficiency |
| 13, 13′ | portion of composite region |
| 14 | interface |
| 15 | interruption |
| 16, 16′ | group of portions |
| 17 | angled region of interface |
| 18 | recess |
| 19 | curvature |
| 20 | external composite region |
| 21 | effectuant |
| 22 | boundary layer |
| 23 | first packaging article |
| | constituent |
| 24 | second packaging article |
| | constituent |
| 25 | cavity |
| 26 | packaged contents |
| 27 | contact area |
| x | first direction |
| y | second direction |
| z | third direction |
| A | separation |

1. An attachable composite with a sheetlike extent, a composite face which extends in a first direction and in a second direction, said second direction being essentially perpendicular to the first direction, and with a composite thickness, which extends in a third direction which is essentially perpendicular to the composite face, wherein
the composite is formed of a two-dimensionally extrudable or extruded first composite region and at least one two-dimensionally extrudable or extruded, preferably co-extruded, second composite region which at least portionally adjoins the first composite region,
the first and/or the second composite region comprises an adhesive,
the second composite region has adherent properties so that the composite is attachable, specifically rereleasably attachable, with the composite face to a surface of a body or to surfaces of two or more bodies, and
the composite is carrierless.

2. The composite as claimed in claim, characterized in that the composite is disposed on a substrate.

3. The composite as claimed in claim 1, characterized in that the first composite region and the second composite region have adherent properties.

4. The composite as claimed in claim 1, characterized in that the first and/or the second composite region comprises an adhesive which has a food contact suitability and which is preferably of the foil type.

5. The composite as claimed in claim 1, characterized in that the adhesive is formed of a specifically reactivatable hot-melt adhesive.

6. The composite as claimed in claim 1, characterized in that the first composite region has a composite region thickness, which is essentially parallel to the third direction and with which the surface-attaching effect of the second composite region is functionally augmented or augmentable.

7. The composite as claimed in claim 1, characterized in that the adherent properties of the composite to the surface of a body are influenceable by the first and/or the second composite region being formed of a material whose composition is adapted to the material forming the surface of the body, wherein the adherent properties comprise the strength of adherence, the rate of adherence, the adherence formation pressure, the adherence duration, the adherence outlay and/or the redetachability of the composite.

8. The composite as claimed in claim 1, characterized in that at least the first composite region is formed as a layer of the composite, said layer having a sheetlike extent which is in an essentially parallel orientation to the sheetlike extent of the composite and which is preferably essentially equiareal to the two-dimensional extent of the composite.

9. The composite as claimed in claim 8, characterized in that the second composite region is at least portionally built up on the first composite region, rendering the composite at least portionally multilayered, and in that, preferably, the composite region thickness of the first and/or of the second composite region varies at least portionally along the first direction and/or along the second direction.

10. The composite as claimed in claim 1, characterized by two or more, specifically sheetlike or stripy, portions in which the first and the second composite regions mutually adjoin along an interface.

11. The composite as claimed in claim 10, characterized in that the portions form an essentially regular pattern where a first portion or a first group of portions have an essentially constant separation from at least one second portion or from at least one second group of portions along the first direction and/or along the second direction.

12. The composite as claimed in claim 10, characterized in that the interface extends at least regionally essentially parallel to the composite face.

13. The composite as claimed in claim 10, characterized in that the interface extends at least regionally essentially perpendicularly to the composite face.

14. The composite as claimed in claim 10, characterized in that the interface comprises at least one angled region.

15. The composite as claimed in claim 10, characterized by an at least regionally curved interface.

16. The composite as claimed in claim 2, characterized by an external composite region disposed such that the first and the second composite regions are disposed between the external composite region and the substrate.

17. The composite as claimed in claim 16, characterized in that the external composite region is disposed on the second composite region in an at least portionally adherent manner.

18. The composite as claimed in claim 1 for creating a specifically durably adherent bond between at least one first material and at least one second material such that the first composite region adheres to the first material and the second composite region adheres to the second material, characterized in that the composite regions of the composite after creating the bond between the two materials are separable such that the materials to which the composite regions adhere have, following the separation of the composite regions, a varietal purity sufficient for recovery of the materials.

19. The composite as claimed in claim 18, characterized by an activatable effectuant which on activation effectuates the separation of the composite regions.

20. The composite as claimed in claim 19, characterized in that the effectuant is disposed in the region of the interface between the composite regions of the composite.

21. The composite as claimed in claim 19, characterized by a boundary layer which comprises the effectuant and which is disposed in the region between the first composite region and the second composite region.

22. The composite as claimed in claim 19, characterized in that the effectuant is activatable by changing the energy balance of the effectuant, for instance by an input of energy into the effectuant, in particular by electric energy, thermal energy, radiative energy, sonic energy or combinations thereof.

23. A method of using a composite as claimed in claim 1, characterized in that the composite serves to label or identify the body to whose surface the composite is attachable.

24. The method as claimed in claim 23, characterized in that printing and/or writing can be applied to the composite.

25. A method of using a composite as claimed in claim 1, characterized in that a material can be applied to the composite to cause the composite to serve as adherent for the material attachable to the surface of the body.

26. The method as claimed in claim 23, characterized in that the composite can be wound up on a cylinder or roll and/or unwound off a cylinder or roll.

27. A method of using a composite as claimed in claim 1, characterized in that the composite is a packaging article or a packaging article constituent, especially a food packaging article or a food packaging article constituent.

28. A packaging article with a first packaging article constituent (23) and at least a second packaging article constituent wherein the packaging article constituents bound at least portionally one or more preferably airtightly sealed cavities to accommodate the packaged contents, characterized in that the first packaging article constituent and/or the second packaging article constituent is formed of a composite, in that the first and the second packaging article constituents are at least portionally in contact with each other to form at least one contact face as well as one or more preferably airtightly sealed cavities to accommodate the packaged contents, and in that the first packaging article constituent and the second packaging article constituent are bondable or bonded to each other by specifically thermal input of energy in the region of the contact face.

29. The packaging article as claimed in claim 28, characterized in that the composite comprises a substrate composed of a polymeric foil, especially a polyethylene terephthalate foil.

30. The packaging article as claimed in claim 28, characterized in that the first composite region of the composite comprises a hot-melt adhesive and in that the second composite region of the composite comprises an adhesive which has a food contact suitability and which is preferably of the foil type.

31. The packaging article as claimed in claim 28, characterized in that the second packaging article constituent is formed of a polymeric foil, especially a polyethylene terephthalate foil (PET foil) or comprises a polymeric foil, especially a polyethylene terephthalate foil (PET foil).

32. A process for producing a packaging article, in particular a packaging article comprising a first packaging article constituent and at least a second packaging article constituent wherein the packaging article constituents bound at least portionally one or more preferably airtightly sealed cavities to accommodate the packaged contents, characterized in that the first packaging article constituent and/or the second packaging article constituent is formed of a composite, in that the first and the second packaging article constituents are at least portionally in contact with each other to form at least one contact face as well as one or more preferably airtightly sealed cavities to accommodate the packaged contents, and in that the first packaging article constituent and the second packaging article constituent are bonded preferably airtightly to each other by specifically thermal input of energy in the region of the contact face.

33. The process as claimed in claim 32, characterized in that the first and/or second packaging article constituent formed of the composite is formed by co-extrusion of the composite regions onto a substrate.

34. The process as claimed in claim 32, characterized in that the first and/or the second composite region comprises an adhesive which has a food contact suitability and which is preferably of the foil type.

35. The process as claimed in claim 32, characterized in that the second packaging article constituent is thermoformed from a polymeric foil, especially a polyethylene terephthalate foil (PET foil).
